(19) United States
(12) Patent Application Publication
(10) Pub. No.: US 2016/0358135 A1
(43) Pub. Date: Dec. 8, 2016

(54) DIGITAL CURRENCY MANAGEMENT METHOD AND DIGITAL CURRENCY NODE APPARATUS

(71) Applicants: DiQi, Inc., Apia (WS); WIFIRE OPEN NETWORK GROUP LIMITED, Hong Kong (HK)

(72) Inventors: Shih-Wei Liao, Taipei City (TW); Yung-Chen Hsieh, Tainan City (TW)

(21) Appl. No.: 14/874,482

(22) Filed: Oct. 5, 2015

(30) Foreign Application Priority Data
Jun. 5, 2015 (CN) 201510305610.7

(51) Int. Cl. G06Q 20/10; G06Q 20/06

(52) U.S. Cl. CPC G06Q 20/10; G06Q 20/06

(57) ABSTRACT

A digital currency management method and a digital currency node apparatus for a digital currency network based on a block-chain are provided. The method includes: determining whether a transaction is generated, performing a proof-of-work mechanism if the transaction is generated. The method also includes: not performing the proof-of-work mechanism if no transaction is generated. In addition, the proof-of-work mechanism includes: obtaining a pre-block and calculating a pre-hash value of the pre-block; and finding a current verification value according to the pre-hash value. Accordingly, a newly generated transaction could be processed immediately and the waste of computing resource in the digital currency network could be reduced.

### CROSS-REFERENCE TO RELATED APPLICATION

This application claims the priority benefit of China application serial no. 201510305610.7, filed on Jun. 5, 2015. The entirety of the above-mentioned patent application is hereby incorporated by reference herein and made a part of this specification.

### BACKGROUND

Field of the Invention

The invention is directed to a digital currency system and more particularly, to a digital currency management method and a digital currency node apparatus.

Description of Related Art

At present, various kinds of digital currencies using a block chain-based technique, such as Bitcoin, Litecoin and so on, start to be popular and have been widely used on the interne. The transaction amount of the digital currencies per day has already exceed millions upon millions US dollars and keeps growing continuously. Currently, many famous companies and organizations support transaction manners using the digital currency, in which a Bitcoin system is taken as a representative.

Currently, Bitcoin is the most widely accepted one among the digital currencies which is a completely point-to-point (P2P) digital currency system and can allow two parties of a transaction to compete the payment directly, such that the payment mode for the transaction through a third party (e.g., a bank) can be discarded to achieve a whole new digital currency system.

However, in a Bitcoin block-chain, it needs ten minutes for generating a new block, and the newly generated block has to be verified through a node in a Bitcoin network. In other words, in the Bitcoin network, it takes a long time to wait for confirming the completion of a transaction after the transaction occurs. Additionally, in Bitcoin, “the generation of a block” and “the generation of a transaction” are two independent mechanisms, and thus, in case no transaction is generated, a new block is still generated in the Bitcoin block-chain to get a reward, which leads to a lengthy block-chain and the waste in memory spaces. Moreover, the node in the Bitcoin network for calculating and generating the block having no transaction cause the waste of node resource for performing a proof-of-work mechanism.

### SUMMARY

The invention provides a digital currency management method and a digital currency node apparatus which can contribute to processing a transaction immediately and reduce the waste of computing resource in a digital currency network.

According to an embodiment of the invention, a digital currency management method for a digital currency network based on a block-chain is provided. The method includes: determining whether a transaction is generated and performing a proof-of-work mechanism if the transaction is generated. The method also includes: not performing the proof-of-work mechanism if no transaction is generated. In addition, the proof-of-work mechanism includes: obtaining a pre-block and calculating a pre-hash value of the pre-block; and finding a current verification value of a current block according to the pre-hash value. The current verification value is configured to verify validity of the current block.

In an embodiment of the invention, the digital currency management method further includes publishing the current verification value if the current verification value of the current block is found.

In an embodiment of the invention, the digital currency management method further includes not obtaining a reward corresponding to the found current verification value of the current block.

In an embodiment of the invention, the digital currency management method further includes receiving a to-be-confirmed verification value corresponding to a to-be-confirmed block; and verifying validity of the to-be-confirmed block according to the to-be-confirmed verification value.

In an embodiment of the invention, the digital currency management method further includes dynamically adjusting a difficulty degree of finding the current verification value used in the proof-of-work mechanism from a first difficulty degree to a second difficulty degree. The first difficulty degree and the second difficulty degree are different.

According to an embodiment of the invention, a digital currency node apparatus adapted for a digital currency network based on a block-chain is provided. The digital currency node apparatus includes a storage unit and a processor. The storage unit is configured to store a plurality of modules. The processor is coupled to the storage unit and is configured to load and execute the modules from the storage unit to determine whether a transaction is generated and perform a proof-of-work mechanism if the transaction is generated. The proof-of-work mechanism includes:

obtaining a pre-block and calculating a pre-hash value of the pre-block; and finding a current verification value of a current block according to the pre-hash value, where the current verification value is configured to verify validity of the current block. In addition, the processor does not perform the proof-of-work mechanism if no transaction is generated.

In an embodiment of the invention, the processor is further configured to load and execute the modules from the storage unit to publish the current verification value if the current verification value of the current block is found.

In an embodiment of the invention, the digital currency node apparatus does not obtain a reward corresponding to the found current verification value of the current block.

In an embodiment of the invention, the processor is further configured to load and execute the modules from the storage unit to receive a to-be-confirmed verification value corresponding to a to-be-confirmed block and verify validity of the to-be-confirmed block according to the to-be-confirmed verification value.

In an embodiment of the invention, the processor is further configured to load and execute the modules from the storage unit to dynamically adjust a difficulty degree of finding the current verification value used in the proof-of-work mechanism from a first difficulty degree to a second difficulty degree, where the first difficulty degree and the second difficulty degree are different.

To sum up, the digital currency management method and the digital currency node apparatus can determine whether a transaction is generated and perform the proof-of-work mechanism only when the transaction is generated. Thereby, the transaction can be processed immediately, and the waste of computing resource in the digital currency network can be reduced.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a digital currency node apparatus according to an embodiment of the invention.

FIG. 2 is a schematic diagram illustrating a transaction mode of a digital currency according to an embodiment of the invention.

FIG. 3 is a schematic diagram illustrating a block-chain according to an embodiment of the invention.

FIG. 4 is a schematic diagram illustrating a digital currency management method according to an embodiment of the invention.

FIG. 5 is a flowchart illustrating a digital currency management method according to an embodiment of the invention.

### DESCRIPTION OF EMBODIMENTS

The invention provides a digital currency management method and a digital currency node apparatus adapted for a digital currency network based on a block-chain technique. The digital currency management method and the digital currency node apparatus can contribute to immediately processing a newly generated transaction and reducing the waste in computing resource of a digital currency network. Additionally, in some embodiments, the digital currency management method and the digital currency node apparatus can further contribute to effectively reducing the time for generating a new block in a block-chain and controlling the publication of a digital currency with more effectiveness. Specially, the digital currency management method and the digital currency node apparatus provided by the invention are not limited to be applied in a specific known or unknown digital currency.

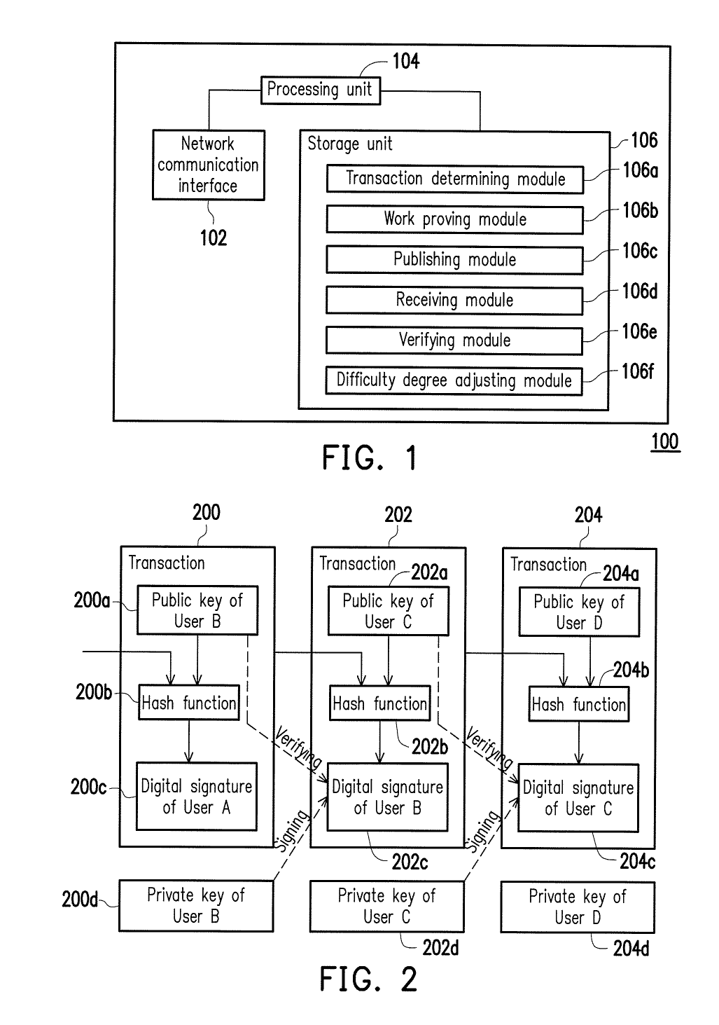

FIG. 1 is a schematic block diagram illustrating a digital currency node apparatus according to an embodiment of the invention.

With reference to FIG. 1, a digital currency node apparatus 100 of the present embodiment includes a network communication interface 102, a processing unit 104 and a storage unit 106.

In the present embodiment, the network communication interface 102 may support, for example, a wireless transceiver unit complying with a wireless communication standard, e.g., the Institute of Electrical and Electronics Engineers (IEEE) 802.11n/b/g, which may establish network connection with other external apparatuses through a wireless manner. Additionally, the network communication interface 102 may also establish network connection with other external apparatuses through a protocol, such as third generation telecommunication (3G), long teem evolution (LTE), Wi-Fi or Bluetooth, in a wireless manner. For example, the network communication interface 102 may have a wireless transceiver unit, such as an antenna. Additionally, the network communication interface 102 may also include a network card supporting wired network connection, which is not limited in the invention.

The processing unit 104 is electrically connected with the network communication interface 102 and the storage unit 106. The processing unit 104 includes a central processing unit (CPU), a graphic processing unit (GPU), a field-programmable gate array (FPGA) or any other chip with processing and computing capabilities.

The storage unit 106 is electrically connected to the processing unit 104. The storage unit 106 may include a static random access memory (SRAM), a dynamic random access memory (DRAM), a hard drive disk (HDD) or any other storage medium configured for storing electronic signals or data.

In the present embodiment, the storage unit 106 stores a plurality of modules, in which the modules are stored in a format of program codes in the storage unit 106. The processing unit 104 may load the modules to implement a digital currency management method of the invention.

In the present embodiment, the storage unit 106 stores a transaction determining module 106a, a work proving module 106b, a publishing module 106c, a receiving module 106d, a verifying module 106e and a difficulty degree adjusting module 106f. Additionally, the storage unit 106 may also store information, such as block-chains related to historic transaction in the digital currency network.

The transaction determining module 106ais configured to determine whether a transaction is generated in the digital currency network based on the block-chain technique. To be specific, the transaction determining module 106a may determine whether a transaction is generated according to the information received from the digital currency network through the network communication interface 102.

The work proving module 106b is configured to determine whether to perform a proof-of-work mechanism according to a determination result of the transaction determining module 106a. To be specific, if the transaction determining module 106a determines that a transaction is generated in the digital currency network, the work proving module 106b performs a proof-of-work mechanism. If the transaction determining module 106a determines that no transaction is generated in the digital currency network, the work proving module 106b does not perform the proof-of-work mechanism. For instance, if the work proving module 106b does not perform the proof-of-work mechanism, the work proving module 106b may be in an idle state. In the proof-of-work mechanism, the work proving module 106b obtains at least one pre-block, calculates a pre-hash value of the pre-block and find a current verification value of a current block according to the pre-hash value. The current verification value is for verifying validity of the current block.

The publishing module 106c is configured to publish the current verification value when the work proving module 106b finds the current verification value of the current block, such that the other digital currency node apparatuses in the digital currency network is informed of the generation of the verification value.

The receiving module 106d is configured to receive a verification value to be confirmed (also known as to-be-confirmed verification value in the following) corresponding to a block to be confirmed (also known as to-be-confirmed block in the following). To be specific, if the digital currency node apparatus 100 receives a to-be-confirmed block and a to-be-confirmed verification value through the network communication interface 102, it indicates that there is already another digital currency node apparatus generating a verification value for verifying a newly generated block faster than the digital currency node apparatus 100 in the digital currency network.

The verifying module 106e is configured to verify the validity of the to-be-confirmed block according to the to-be-confirmed verification value. To be specific, if the receiving module 106d receives the to-be-confirmed block and the to-be-confirmed verification value, the verifying module 106e verifies validity of the to-be-confirmed block according to the to-be-confirmed verification value.

The difficulty degree adjusting module 106f is configured to dynamically adjust a difficulty degree of finding current verification value used in the proof-of-work mechanism (i.e., during performing the proof-of-work mechanism) from a first difficulty degree to a second difficulty degree, where the first difficulty degree and the second difficulty degree are different.

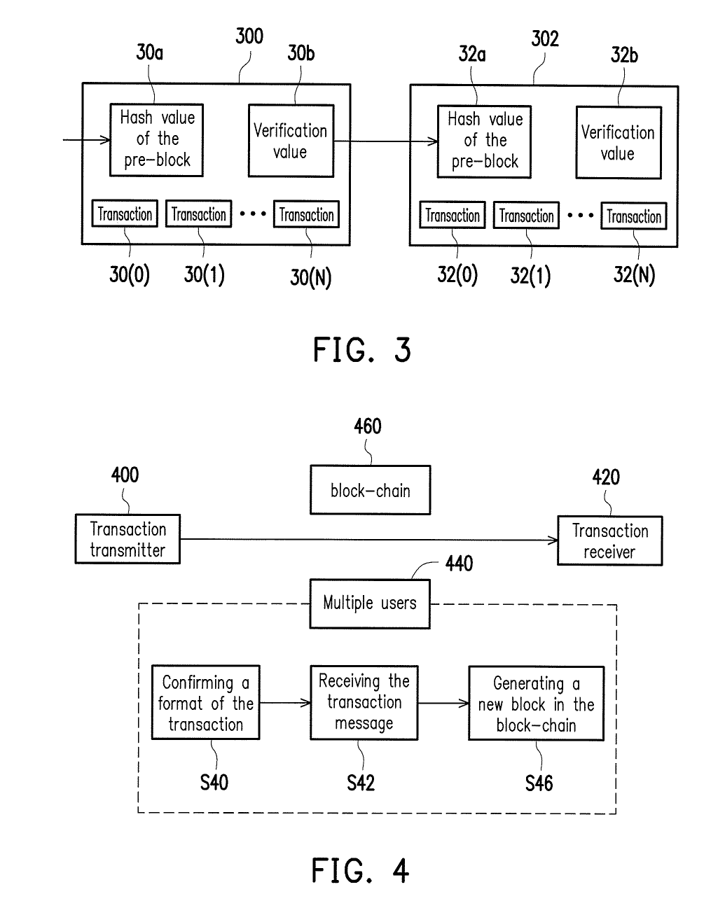

Operations of the transaction determining module 106a, the work proving module 106b, the publishing module 106c, the receiving module 106d, the verifying module 106e and the difficulty degree adjusting module 106f will be described with reference to FIG. 2 together with FIG. 3 below.

FIG. 2 is a schematic diagram illustrating a transaction mode of a digital currency according to an embodiment of the invention.

With reference to FIG. 2, if a user B wants to pay a certain amount of digital currency to a user C (i.e., a transaction 202 in FIG. 2), the transaction 202 contains the amount and a source of the amount to be transacted. Referring to FIG. 2, the amount that the user B wants to pay user C is inherited from a transaction 200, and according to a digital signature 200c of a user A in the transaction 200, the amount owned by the user B comes from the user A. Then, the content of the transaction 200 and a public key 202a of the user C is input into a hash function 202b to obtain a string of digits. Finally, the user B signs the string of digits by using a private key 200d of the user B, which serves as a digital signature 202c of the user B and is stored in the transaction 202.

After receiving the transaction 202, the user C may find the transaction 200 through an ID of the transaction 200 stored in the transaction 202. Then, the user C may decrypt the digital signature 202c of the user B in the transaction 202 according to a public key 200a of the user B. In the meantime, the user C inputs the public key 202a of the user C and the content of the transaction 200 into the hash function 202b to obtain a character string and compares the character string with the decrypted result of the digital signature 202c.

If the comparison result indicates that the character string and the decrypted result are the same, it may prove that the currency source from the user B is true. To be specific, the transaction 200 contains the digital signature of the user A, and the transaction 200 is verified by most users in the digital currency network, and thus, it proves that the currency source from the user B is true. Additionally, since the private key of the user B is unique, it may confirm that the transaction is issued by the user B.

In brief, a private key (e.g., the private key 200d of the user B) of a transaction transmitter (or transaction issuer) is used to sign the content of the transaction to generate a digital signature, which indicates the source is from the user B. A public key (e.g., the public key 200a of the user B) of the transaction issuer is used for a transaction receiver to verify the digital signature to verify whether the source and the content are correct. In addition, the public key (e.g., the public key 202a of the user C) of the transaction receiver is a payment receiving address of the transaction receiver.

When the transaction 202 is verified by all or most of the users in the digital currency network, the user C may obtain the content of the transaction 202 according to the aforementioned manners and further issue a transaction 204 to a user D according to the content of the transaction 202. For instance, the transaction 204 contains a digital signature of the user C generated by using a public key 204a of the user D, a hash function 204b and a private key 204c of the user C, and a private key 204d of the user D may be used to verify a source of the next corresponding transaction, and so on.

It should be noted that under a digital currency architecture using a block chain-based technique, each transaction records the former, the current and the latter owners of an amount, and thereby, tracing of the money (i.e., digital currency) can be achieved for whole digital currency network according to the transaction records. Moreover, when each transaction is established, the user who establishes the transaction may broadcast the existence of the transaction to at least one node (e.g., the digital currency node apparatus 100) for processing the transaction in the digital currency network, such that each node may generate a block (which is one of the blocks that is not yet added in the block-chain) according to the transaction received through the broadcasting and perform a proof-of-work mechanism on the block. Among the nodes, a node that first calculate a current verification value by the proof-of-work mechanism in the digital currency network may add the block together with the current verification value in the block-chain.

To be specific, each node conserves a block-chain (each node has the same block-chain content) of the former transaction. When a new transaction being generated is detected, each node generates a hash value according to the last block (i.e., a pre-block) in the block-chain by using the content of the last block in the block-chain as an input. Then, each node may verify new transactions received from the digital currency network and combine the transactions that are not listed in the pre-block to generate a new block (i.e., a current block). Thereafter, each node in the digital currency network attempts to find out a random number (i.e., a current verification value) by means of a trial and error method. In the present embodiment, the hash value generate according to the content of the pre-block, the new block containing the multiple transactions and the found random number are input into a hash function (e.g., an SHA256 hash function) to calculate a sequence, and then, whether values of former N bits in the sequence are 0 is determined, where N is 10, for example.

It should be noted that by means of dynamically adjusting the value of N, a difficulty degree of finding the current verification value in the proof-of-work mechanism may be dynamically adjusted from a first difficulty degree to a second difficulty degree, in which the first difficulty degree and the second difficulty degree are different. To be specific, as the value of N is smaller, the difficulty of finding the current verification value is lower, and as the value of N is greater, the difficulty of finding the current verification value is higher.

Due to each node in the digital currency network having different computing capabilities, when a node finds the current verification value, and the current verification value satisfies the sequence generated by being input to the hash function, in which the values of the former N bits are 0, the node that first finds the current verification value published the current block and the current verification value, in which the current block contains the current verification value, the hash value of the pre-block and the new transactions.

Afterwards, at least a portion of the nodes in the digital currency network verify the new block in the block-chain. To be specific, when at least one of the other nodes receives a certain block and a verification value corresponding to the block, the at least one node performs verification according to the block and the verification value. If the verification result is true, the at least one node in the digital currency network accepts the newly generated block and conserves the newly generated block together with the former block-chain; otherwise discards the block.

FIG. 3 is a schematic diagram illustrating a block-chain according to an embodiment of the invention.

With reference to FIG. 3, it is assumed that a block 302 is a new block generated in the digital currency network by means of the proof-of-work mechanism, and the block 302 is not yet verified by other nodes in the digital currency network. When the block 302 is generated, the node generating the block 302 publishes information with respect to the block 302, where the block 302 contains a hash value 32a (which is also referred to as a pre-hash value) of the pre-block 300, a current verification value 32b and transactions 32(0) to 32(N). When receiving the block to be confirmed (i.e., the block 302) and the verification value to be confirmed (i.e., the current verification value 32b), the at least one node in the digital currency network verifies the block to be confirmed according to the verification value to be confirmed. To be specific, the at least one node in the digital currency network inputs the hash value 32a, the current verification value 32b and the transactions 32(0) to 32(N) of the current block which are contained in the block 302 into a hash function (e.g., an SHA256 hash function) to calculate a sequence and determines whether the sequence meets the rule that values of former N bits are 0. If yes, the nodes in the digital currency network accepts the newly generated block and also conserves the newly generated block together with a block-chain of the pre-block 300; otherwise discards the block.

It should be noted that each block stores transaction records among the users, and the blocks in the block-chain are serially connected in serial, thus, all transaction records generated since the digital currency network is created may be found by means of the connection relations between each block. For instance, the block 302 is connected with the pre-block 300, the block 300 also connected to other pre-block (which is not shown), and the block 300 also contains other former transactions 30(0) to 30(N), and thus, the user may look up in the transaction records according to the blocks in the block-chain.

In the present embodiment, the work proving module 106b may perform the process of generating a new block illustrated in FIG. 3 only when a transaction is generated, and thereby, the generation of the block having no transaction data may be reduced, such that a storage space of each node for storing the block-chain may be saved, and the tracing of the transactions in the block-chain may be easier. Meanwhile, during a period of time that no transaction is generated, the node may be idle for a period of time to perform other operations.

In the present embodiment, the difficulty degree of finding the current verification value in the proof-of-work mechanism may be adjusted to a lower degree, which may facilitate in, when a transaction is generated, speeding up the generation of the block and in effectively reducing the time for processing the transaction. For instance, the difficulty degree adjusting module 106f may adjust the difficulty degree of finding the current verification value in the proof-of-work mechanism from a first difficulty degree to a second difficulty degree, where the first difficulty degree is smaller than the second difficulty degree. For instance, if it needs 10 minutes for calculating a verification value of a new block in the conventional Bitcoin system, the work proving module 106b may calculate the current verification value of the current block within only 15 seconds after the difficulty degree of finding the current verification value in the proof-of-work mechanism is adjusted from the first difficulty degree to the second difficulty degree.

It should be noted that in an embodiment, when the current verification value of the current block published by the first node is verified by another node in the digital currency network, the node does not obtain an additional reward. Thus, in comparison with the reward system of Bitcoin, each node in the digital currency network of the invention does not perform unnecessary computation when no transaction is received, and thereby, the computing resource of the entire digital currency network can be saved, and the issuance of the digital currency can be controlled with more effectiveness.

Additionally, in the invention, it needs less time for calculating the current verification value of the current block, and a digital currency network commonly has a smaller amount of transactions when it is initially created, and thus, the generation of the block having no transaction data may be prevented, and the storage space for storing the block-chain may be saved by means of conditionally performing the proof-of-work mechanism and lowering down the difficulty degree of the proof-of-work mechanism.

FIG. 4 is a schematic diagram illustrating a digital currency management method according to an embodiment of the invention.

With reference to FIG. 4, if it is assumed that a transaction issuer 400 wants to issue a transaction to a transaction receiver 420, a new block in a block-chain 460 is generated through one of multiple users 440 in a digital currency network to confirm validity of the transaction. To be specific, when the transaction is generated, in step S40, the transaction issuer 400 first confirms a format of the transaction is correct, i.e., whether the transaction contains data that need to be filled in the transaction. If the format of the transaction is correct, the transaction is broadcasted to the multiple users 440 in the digital currency network by the transaction issuer 400. In step S42, the multiple users 440 in the digital currency network receive the transaction transmitted in step S40. Then, in step S42, the multiple users 440 in the digital currency network verify the format of the received transaction and ensure validity of the transaction record, and then a message regarding the validity and the correctness of the format of the transaction are added in a block, and a verification value is generated by a proof-of-work mechanism. Thereafter, in step S46, one of the multiple users 440 in the digital currency network generates a new block in the block-chain 460, and the other users in the digital currency network may verify the block. If a verification result of the block is correct, it indicates that the transaction content in the newly generated block is true; if an error occurs in the verification result of the block, the newly generated block is discarded. By means of combining the aforementioned generation manned of the block with the lowering down of the difficulty degree in the proof-of-work mechanism of the invention, the time for generating the new block can be effectively shortened.

It should be noted that each node or each user in the digital currency network mentioned in each of the embodiments above may be considered as a digital currency node apparatus 100.

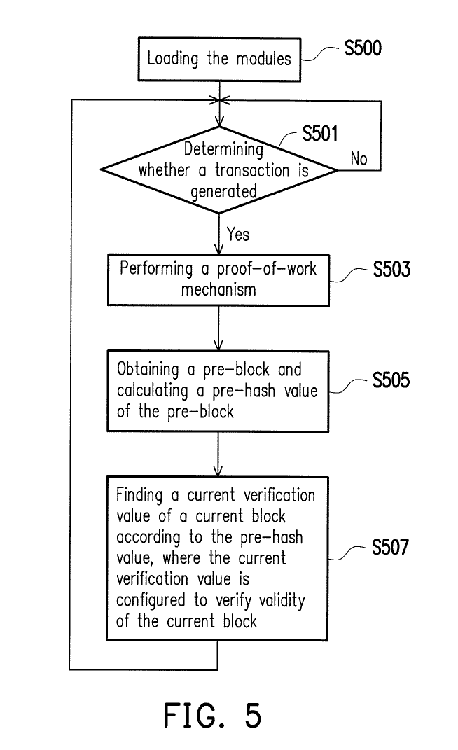

FIG. 5 is a flowchart illustrating a digital currency management method according to an embodiment of the invention.

With reference to FIG. 5, in step S500, a plurality of modules stored in the storage unit is loaded to perform a digital currency management method of the invention. In step S501, whether a transaction is generated in the digital currency network is determined. If the transaction is generated in the digital currency network, in step S503, a proof-of-work mechanism is performed. In step S505, a pre-block is obtained, and a hash value of the pre-block is calculated. Then, in step S507, a current verification value of a current block is found according to the hash value of the pre-block, where the current verification value is for verifying validity of the current block. Then, step S501 is returned to. If no generation is generated in the digital currency network in step S501, step S503 is not performed.

It should be noted that in the embodiments above, the transaction determining module 106a, the work proving module 106b, the publishing module 106c, the receiving module 106d, the verifying module 106e and the difficulty degree adjusting module 106f are implemented in a form of software. Alternatively, in another embodiment, the transaction determining module 106a, the work proving module 106b, the publishing module 106c, the receiving module 106d, the verifying module 106e and the difficulty degree adjusting module 106f may also implemented in a form of hardware circuits and configured in the digital currency node apparatus 100, which is not limited in the invention. For example, these modules may be performed by the field-programmable gate array.

Additionally, each step depicted in FIG. 4 and FIG. 5 may also be implemented in a form of software or hardware. The method depicted in FIG. 4 and FIG. 5 may also be implemented in combination with each of the embodiments above or solely, and the invention is not limited thereto.

In light of the foregoing, the invention can achieve quick transaction by means of lowering down the difficulty degree of the proof-of-work mechanism. Moreover, by means of conditionally performing the proof-of-work mechanism, the waste of the user apparatus sources in the digital currency network can be reduced, and the generation of the block having no transaction data in the block-chain can be effectively prevented.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A digital currency management method, adapted for a digital currency network based on a block-chain, the digital currency management method comprising:
determining whether a transaction is generated;
performing a proof-of-work mechanism if the transaction is generated, wherein the step of performing the proof-of-work mechanism comprises:
obtaining a pre-block and calculating a pre-hash value of the pre-block; and
finding a current verification value of a current block according to the pre-hash value, wherein the current verification value is for verifying validity of the current block; and
not performing the proof-of-work mechanism if no transaction is generated.

2. The digital currency management method according to claim 1, further comprising:
publishing the current verification value if the current verification value of the current block is found.

3. The digital currency management method according to claim 2, further comprising:
not obtaining a reward corresponding to the found current verification value of the current block.

4. The digital currency management method according to claim 1, further comprising:
receiving a to-be-confirmed verification value corresponding to a to-be-confirmed block; and
verifying validity of the to-be-confirmed block according to the to-be-confirmed verification value.

5. The digital currency management method according to claim 1, further comprising:
adjusting, dynamically, a difficulty degree of finding the current verification value used in the proof-of-work mechanism from a first difficulty degree to a second difficulty degree, wherein the first difficulty degree and the second difficulty degree are different.

6. A digital currency node apparatus, adapted for a digital currency network based on a block-chain, the digital currency node apparatus comprising:
a storage unit, configured to store a plurality of modules; and
a processor, coupled to the storage unit and configured to load and execute the modules from the storage unit to:
determine whether a transaction is generated; and
perform a proof-of-work mechanism if the transaction is generated, wherein the proof-of-work mechanism comprises:
obtaining a pre-block and calculating a pre-hash value of the pre-block; and
finding a current verification value of a current block according to the pre-hash value, wherein the current verification value is for verifying validity of the current block,
wherein the processor does not perform the proof-of-work mechanism if no transaction is generated.

7. The digital currency node apparatus according to claim 6, wherein the processor is further configured to load and execute the modules from the storage unit to:
publish the current verification value if the current verification value of the current block is found.

8. The digital currency node apparatus according to claim 7, wherein the digital currency node apparatus does not obtain a reward corresponding to the found current verification value of the current block.

9. The digital currency node apparatus according to claim 6, wherein the processor is further configured to load and execute the modules from the storage unit to:
receive a to-be-confirmed verification value corresponding to a to-be-confirmed block; and
verify validity of the to-be-confirmed block according to the to-be-confirmed verification value.

10. The digital currency node apparatus according to claim 6, wherein the processor is further configured to load and execute the modules from the storage unit to:
adjust, dynamically, a difficulty degree of finding the current verification value used in the proof-of-work mechanism from a first difficulty degree to a second difficulty degree, wherein the first difficulty degree and the second difficulty degree are different.
